(19) United States
(12) Patent Application Publication
(10) Pub. No.: US 2014/0164362 A1
(43) Pub. Date: Jun. 12, 2014

(54) Systems and Methods for Data Relationship Visualization

(71) Applicant: Parastructure Inc., Mountain View, CA (US)

(72) Inventors: Salik Syed, Vacaville, CA (US); Ryan Noon, Mountain View, CA (US)

(73) Assignee: PARASTRUCTURE INC., Mountain View, CA (US)

(21) Appl. No.: 14/102,116

(22) Filed: Dec. 10, 2013

Related U.S. Application Data
(60) Provisional application No. 61/735,375, filed on Dec. 10, 2012.

(51) Int. Cl. G06F 17/30

(52) U.S. Cl. CPC G06F 17/30994
USPC 707/722

(57) ABSTRACT

Systems and methods for data relationship visualization are disclosed. An exemplary system comprises a processor, database, display, query module, relationship module, and user interface module. The query module may be configured to receive a first query and a second query. The first and second queries may assist in retrieving a first and second query result sets, respectively, from the database. The relationship module may be configured to identify a first subset associated with the first query result set and the second query result set based on at least some of the first query result set and at least some of the second query result set. The user interface may be configured to generate a first node to represent the first query result set, a second node to represent the second query result set, and a first edge between the first node and the second node to represent the first subset.

### CROSS-REFERENCE TO RELATED APPLICATION

The present application claims benefit of U.S. Provisional Patent Application No. 61/735,375, filed Dec. 10, 2012 and entitled “System and Method for Indexing, Visualizing and Exploring Complex Datasets,” which is incorporated herein by reference.

### BACKGROUND

1. Field of the Invention

The present invention generally relates to data visualization. More particularly, the invention(s) relate to data visualization of data analysis.

2. Description of Related Art

As the amount of collected data increases, visualization of that collected data often remains unchanged. Visualization tends to be based on a single query; for example, as a user searches for information from one or more databases, they will submit a single query and the visualization will be the results for that query. The visualization is typically a chart or list.

Some visualizations may appear as a network of connected nodes. For example, a visualization may display a network of computers or computer nodes. These visualizations are also based on the results for a query. A new query typically generates a new visualization. As a result, users typically refine their queries to generate new visualizations in order to access or learn about data.

### SUMMARY

Systems and methods for data relationship visualization are disclosed. An exemplary system comprises a processor, database, display, query module, relationship module, and user interface module. The query module may be configured to receive a first query and a second query. The first and second queries may assist in retrieving a first and second query result sets, respectively, from the database. The relationship module may be configured to identify a first subset associated with the first query result set and the second query result set based on at least some of the first query result set and at least some of the second query result set. The user interface may be configured to generate a first node to represent the first query result set, a second node to represent the second query result set, and a first edge between the first node and the second node to represent the first subset.

In some embodiments, the query module is further configured to receive a third query, the third query to assist in retrieving a third query result set from the database, the relationship module is further configured to identify a second subset associated with the first query result set and the third query result set based on at least some of the first query result set and at least some of the third query result set, and the user interface further is configured to generate on the display a third node to represent the third query result set and a second edge between the first node and the third node to represent the second subset.

In various embodiments, the query module is further configured to receive a third query, the third query to assist in retrieving a third query result set from the database, the relationship module further configured to identify a second subset associated with the first query result set and the third query result set, to identify a third subset of the second query result set and the third query result set, the second subset being based on at least some of the first query result set and at least some of the third query result set, the third subset being based on at least some of the second query result set and at least some of the third query result set, and the user interface further configured to generate on the display a third node to represent the third query result set, a second edge between the first node and the third node to represent the second subset, and a third edge between the second node and the third node to represent the third subset.

In some embodiments, the query module is further configured to receive a third query, the third query to assist in retrieving a third query result set from the database, the relationship module further configured to identify a second subset of the first query result set, the second query result set, and the third query result set, the second subset being based on at least some of the first query result set, on at least some of the second query result set, and at least some of the third query result set, and the user interface further configured to generate on the display a third node to represent the third query result set and an object to represent the second subset. The object may comprise a number of sides, the number of sides being equal to a number of query result sets involved to identify the second subset.

The first subset may be based on shared information between the first query result set and the second query result set. The user interface may be further configured to receive a user selection of the first node and to generate a display of at least some of the members of the first query result set.

In some embodiments, the user interface may be further configured to receive a user selection of the first edge and to generate a display of at least some of the members of the first subset. In various embodiments, the user interface is further configured to receive a user selection of the first node and the first edge and to generate a display of at least some of the shared members of between the first query result set and the first subset. The user interface may be further configured to generate a display of at least some of the shared members of between the first query result set and the first subset comprises the user interface being configured to generate the display of a graph based on the at least some of the shared members of between the first query result set and the first subset.

In some embodiments, the query module is further configured to receive a third query identifying at least one of the query result sets, the third query to assist in retrieving a third query result set from the database, the third query result set comprising at least some members of the identified at least one of the query result sets, the relationship module is further configured to identify a second subset associated with the first query result set and the third query result set based on at least some of the first query result set and at least some of the third query result set, and the user interface further is configured to generate on the display a third node to represent the third query result set and a second edge between the first node and the third node to represent the second subset.

In various embodiments, the query module is further configured to receive a third query identifying at least one of the query result sets, the third query to assist in retrieving a third query result set from the database, the third query result set comprising at least some members of the identified at least one of the query result sets, and the user interface further is configured to generate on the display a third node to represent the third query result set and to remove at least one of the nodes associated with at least one of the identified at least one of the query result sets.

An exemplary method may comprise receiving, by a processor of a digital device, a first query and a second query, the first query to assist in retrieving a first query result set from the database, the second query to assist in retrieving a second query result set from the database, identifying, by the processor, a subset of the first query result set and the second query result set based on at least some of the first query result set and at least some of the second query result set, and generating, on a display of a digital device, a first node to represent the first query result set, a second node to represent the second query result set, and an edge to represent the subset.

An exemplary non-transitory computer readable medium comprising instructions executable by a processor for performing a method, the method comprising receiving, by a processor of a digital device, a first query and a second query, the first query to assist in retrieving a first query result set from the database, the second query to assist in retrieving a second query result set from the database, identifying, by the processor, a subset of the first query result set and the second query result set based on at least some of the first query result set and at least some of the second query result set, and generating, on a display of a digital device, a first node to represent the first query result set, a second node to represent the second query result set, and an edge to represent the subset.

### BRIEF DESCRIPTION OF THE DRAWINGS

FIG. 1 illustrates a diagram of an exemplary environment in which embodiments may be practiced.

FIG. 2 is an exemplary interface in some embodiments.

FIG. 3 is a flowchart for providing a visualization depicting relationships between query result sets in some embodiments.

FIG. 4a depicts an exemplary query field in some embodiments.

FIG. 4b depicts an exemplary node which represents the query result set for the query “customer with age between 20 and 30 and city is ‘Nashville’” in some embodiments.

FIG. 4c depicts exemplary query field as well as exemplary nodes coupled by an edge in some embodiments.

FIG. 5 is a graph depicting selection of a node to generate views in some embodiments.

FIG. 6 is a graph depicting selection of two nodes and an edge to generate views in some embodiments.

FIG. 7 is a graph depicting selection of an edge to generate views in some embodiments.

FIG. 8 depicts a graph depicting how queries across different data types can be joined to depict relationships in some embodiments.

FIG. 9 is a graph depicting edges generated based on affinity calculations in some embodiments.

FIG. 10 is a graph depicting multiple edges in some embodiments.

FIG. 11 is a graph depicting filtering in some embodiments.

FIG. 12 depicts splitting a node into two individual nodes in some embodiments.

FIG. 13 depicts merging two individual nodes into a single node in some embodiments.

FIG. 14 depicts exemplary relationships between three or more nodes in a graph in some embodiments.

FIG. 15 depicts a graph of queries showing customer segmentation in some embodiments.

FIG. 16 is a display of a graph and a dashboard visualization of a bar graph in some embodiments.

FIG. 17 depicts a variety of different visualizations that may be generated by the user interface module and/or depicted on a display in some embodiments.

FIG. 18 is a block diagram of an exemplary digital device.

### DETAILED DESCRIPTION

Some embodiments described herein include systems and methods for discovering relationships and/or patterns in data of which the user may be unaware. In one example, a user may submit multiple queries to query one or more databases. A query result set for each query may be retrieved. The query result set may include information from the database that is relevant to the query. For each query result set a node in a graph may be displayed. The system may also identify relationships between query result sets (e.g., based on information associated with each query result set that may be contained within the database) based on one or more similarity metrics. If there are relationships, the system may generate or identify a subset. If there is a subset and the subset members are greater than zero, the system may display a line (or an edge) between related nodes.

A visualization may depict queries and relationships between nodes related to the queries for the user. As such, the user may identify relationships in data that may have not been previously apparent or known. Prior art systems typically require the user to guess at possible relationships and formulate queries regarding that possible relationship. In some embodiments, systems and methods described herein allow for the discovery of unknown relationships in data.

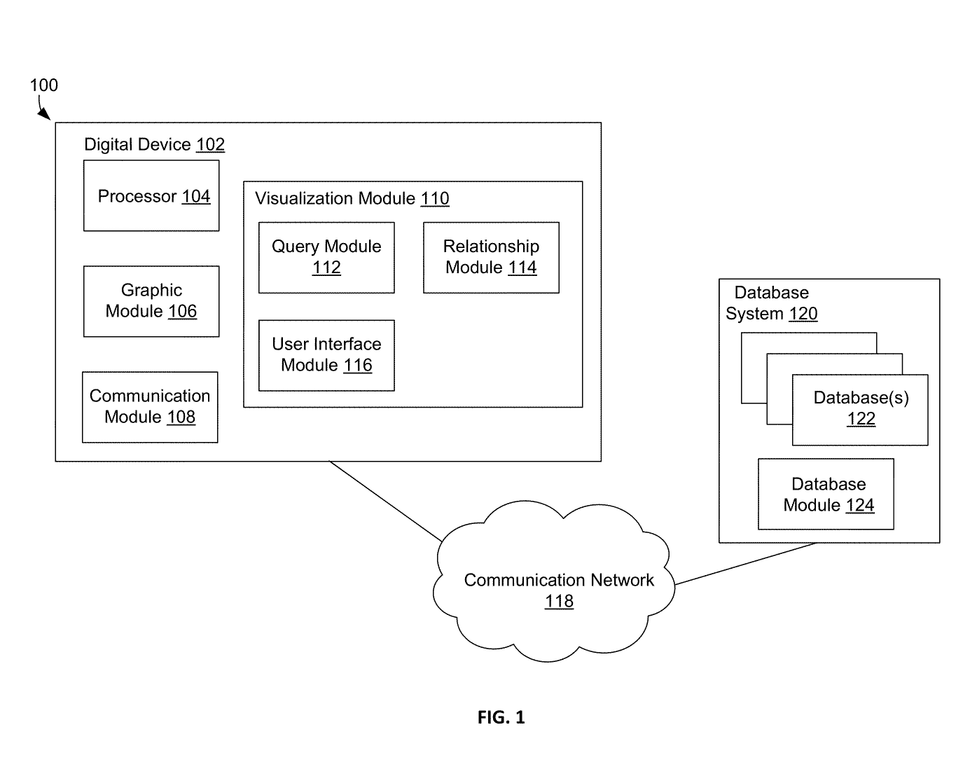

FIG. 1 illustrates a diagram of an exemplary environment 100 in which embodiments may be practiced. Environment 100 comprises a digital device 102, a communication network 118, and database system 120. A digital device is any device with a processor and memory. Examples of digital device may include a computer such as a desktop computer, laptop, server, or the like. The database system 120 may comprise any number of digital devices (e.g., servers). The communication network 118 is any network that supports communication among any number of digital devices. The communication network 118 may comprise wired connections between digital devices and/or wireless connections between digital devices.

The digital device 102 comprises a processor 104, a graphic module 106, a communication module 108, and a visualization module 110. The visualization module 110 comprises a query module 112, a relationship module 114, and a user interface module 116. The processor 104 may be any processor such as a central processing unit, graphics processing unit, microprocessor, or the like. Although exemplary environment 100 depicts a single processor, those skilled in the art will appreciate that the digital device 102 may comprise any number of processors.

The graphic module 106 is any software or hardware configured to render and/or control the display of graphics such as video, images, or the like. In one example, a graphic module 106 is a video card and/or a processor for graphic rendering. In various embodiments, the graphic module 106 may render a data visualization based on information from the visualization module 110. In various embodiments, the graphic module 106 may render images for display with a monitor (e.g., a display). The digital device 102 may comprise or be coupled to the monitor.

The communication module 108 is any interface configured to communicate with another digital device (e.g., over the communication network 118). In one example, the communication module 108 provides queries from the visualization module 110 to the database module 124 of the database system 120 over the communication network 118. In response from the queries, the communication module 108 may receive query response sets from the database module 124 and provide the query response sets to the visualization module 110.

The database system 120 comprises database(s) 122 and a database module 124. There databases(s) 122 may include one or more databases. A database may be any structured set of data. One or more databases of the database(s) 122 may be relational databases, flat file databases, tables, and/or any other type of data structures. In some embodiments, database(s) 122 comprises databases of different types. For example, the databases(s) 122 may comprise multiple independent relational databases with other database structures. The database module 124 may include any number of database management system(s) (DBM). A database management system may be an application that is configured to interact with the user and/or other applications as well as any number of the database(s) in the database(s) 122. The database module 124 may include any number of database management systems including, for example, MySQL, PostgreSQL, Oracle, SAP, dBase, FoxPro, LibreOffice, and the like.

Although the exemplary environment 100 depicts database(s) 122 and a database module 124 on the same digital device, those skilled in the art will appreciate that any database of the database(s) 122 may be on any number of digital devices (e.g., any number of servers). Further, the database module 124 may be on a digital device that is separate from a digital device that hosts all or part of one or more of the database(s) 122.

In some embodiments, the visualization module 110 is configured to receive queries for retrieving query result sets from the database(s), determine relationships (e.g., interrelationships) in the retrieved query result sets, and generate a graph to display representations of the query result sets and relationships. A query may be used to make queries in a database (e.g., database(s) 122). In some embodiments, the query may be classified as a database query language (e.g., a query to retrieve factual information in response to questions). In various embodiments, the query is classified as an information retrieval language (e.g., a query to assist in finding documents, filed, or objects containing information that is relevant to at least an area of inquiry). Those skilled in the art will appreciate that any type of query may be used.

A query result set is any information retrieved from a database in response to a query. For example, if the database comprises documents and the query is directed to search for documents that meet a criteria or criterion, the query result set may include one or more documents, filed, or objects that meet that criteria from the database (e.g., database(s) 122). In some embodiments, the query result set may comprise information from or pointers to information within the database(s) 122. Those skilled in the art will appreciate that a query response set may comprise any number of sets of information from the database(s) 122 that are responsive to the query.

Although a query may be occasionally referred to as a single query, there may be any number of queries. Further, two or more queries may be received simultaneously or near simultaneously. Similarly, information may be retrieved from the database(s) 122 from multiple queries simultaneously or near simultaneously.

In some embodiments, the visualization module 110 may receive a query from a user or application. The query may be a natural language query or be formatted in any number of ways. In some embodiments, the visualization module 110 generates a new query based on the received query (e.g., by formatting a received query formatted in natural language into a form to be used by the database module 124). In some embodiments, the visualization module 110 may provide the query to the database module 124 which utilizes the query to retrieve the query response set from the database(s) 122. The database module 124 may provide the query response set to the visualization module 110 to allow the visualization module 110 to provide a visualization of the query response set.

The query result set may comprise information relevant to the query. In various embodiments, the query response set contains, based on the query, some information from the database(s) 122 on a topic but not all information. For example, if the query requests a list of customers who made a specific purchase, the query result set may include a list of names. Each name in the list however, may be related to other information within the database (e.g., each customer's demographic information or records) that may not be a part of the query result set.

The visualization module 110 may generate a node for each query and/or query result set to be displayed in a graph (e.g., a network). The visualization module 110 may also discover relationships between nodes by assessing relationships in the query result sets. For example, the visualization module 110 may identify a subset of shared members from two query result sets. In another example, the visualization module 110 may direct the database module 124 to assess data associated with information within the query result sets to determine if there is shared information. In the above example, a query result set may include a set of names responsive to a query for customers who made a specific purchase. Another query may include a set of names of customers who are below a specific age. The visualization module 110 may, for example, generate and provide a meta-query to the database module 124 to retrieve information from the database(s) 122 identifying any customers from the query result set of names that are below the specific age. A subset may identify those customers from the query result set of names that are below the specific age.

The visualization module 110 may display a line or edge between nodes that share a subset based on the similarity metric. Although an intersection of data shared between the two query result set is discussed as being a similarity metric, those skilled in the art will appreciate that there are many similarity metrics.

In various embodiments, the query module 112 is configured to receive any number of queries. In one example, a query is received from a user. In another example, a query may be received from an application. Any number of queries may be received from any number of sources.

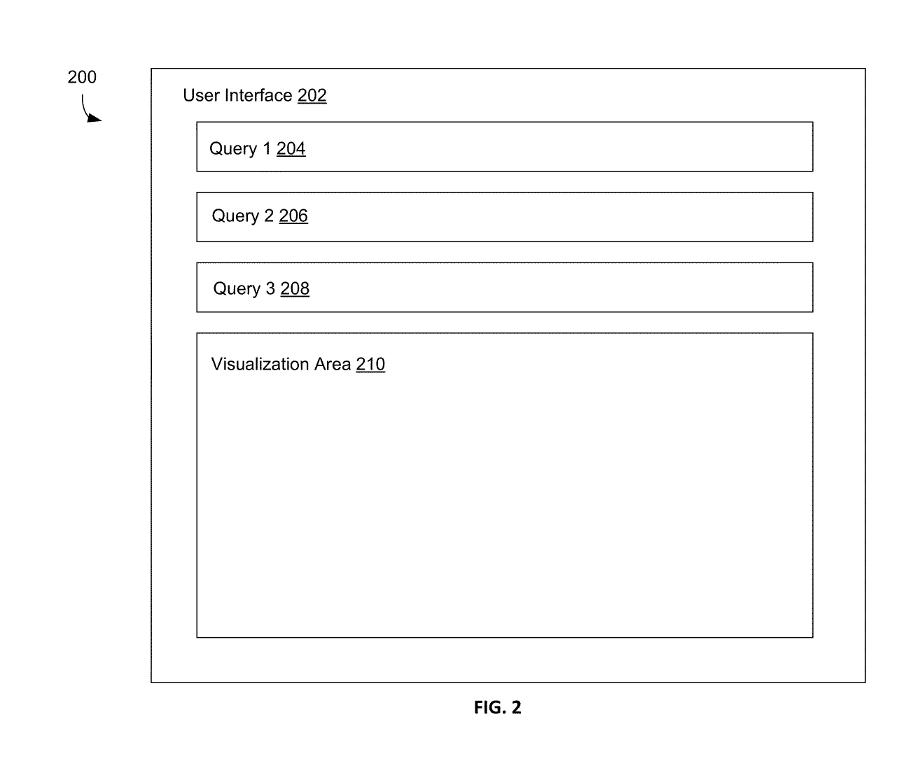

In some embodiments, the query module 112 directs the user interface module 116 to display one or more fields to receive one or more queries from a user or application (see FIG. 2). In some embodiments, the query module 112 may provide the queries to the database module 124 to retrieve query result sets from the database(s) 122 based on the quer(ies). The query module 112 may provide the quer(ies) over the communication network 118 via the communication module 108. In various embodiments, the query module 112 performs all or some of the functions of the database module 112.

In some embodiments, the database module 124 may retrieve information from the database(s) 122 responsive to the quer(ies) and provide the retrieved information to the query module 112 as one or more query result sets. In one example, each query is the basis for information within each query result set. A query result set may have any number of members. For example, a query result set may have any kind of information (e.g., a record, reference, pointer, document, file, data entry, or the like). A query result set may have a plurality of members, each member being of a different type (e.g., one or more members referring to or being a record, reference, pointer, document, file, data entry, or the like). In some embodiments, a query result set may have any number of members or zero members (e.g., when no data responsive to the query was found).

The relationship module 114 is configured to identify subsets (e.g., relationships) of query result sets based on at least some of the query result sets. A subset may contain any information related to the query result sets. Those skilled in the art will appreciate that, in some embodiments, the relationship module 114 may be seen as a meta-query engine configured to generate queries based on previously received queries and/or previously received query result sets. Further, those skilled in the art will appreciate that the subset may not contain the members of any query result set but may include information related to one or more members of any query result set.

For example, the query module 112 may receive a first query to retrieve a first query result set regarding “customers who bought Toy Story toys.” The query module 112 may also receive a second query (simultaneously or serially) to retrieve a second query result set regarding “customers above the age of 30.” The relationship module 114 may retrieve information from the database(s) 122 to identify a subset of the two query result sets that identify those customers above the age of 30 that bought Toy Story toys.

The relationship module 114 may identify subsets among any number of queries, previously retrieved query result sets and/or subsets (e.g., discover relationships between nodes by assessing relationships in the query result sets in view of a similarity metric). For example, a graph may comprise dozens of nodes representing dozens of different queries. When the query module 112 receives or determines a new query result set based on a new query, the relationship module 114 may seek to identify subsets related to query result sets associated with two or more different nodes and/or subsets.

The user interface module 116 may be configured to display nodes that represent one or more query result set(s) and edges between nodes that represent subsets. In various embodiments, the user interface module 116 provides information to the graphic module 106 to display on a display.

Those skilled in the art will appreciate that the query module 112, relationship module 114, and user interface module 116 may, in some embodiments, configure the processor 104 to perform the various functions described herein.

Although the environment 100 depicts the digital device 102 coupled with the database system 120 via the communication network 118, those skilled in the art will appreciate that the database system 120 and the communication network 118 are optional. For example, the digital device 102 may comprise the database(s) 122 and/or the database module 124. The digital device 102 may access one or more databases in any number of ways. For example, the one or more databases may be coupled to the digital device 102 in any number of ways, including but not limited to, over a peer-to-peer network, from a local hard drive, from a remote hard drive, from a thumb drive, from an optical disc, or the like.

Modules may be software or hardware. In some embodiments, methods discussed herein may be performed by executable instructions which may be executable by a processor. The instructions may be stored on a non-transitory computer readable medium such as a hard drive medium, optical medium, or the like.

FIG. 2 is an exemplary interface 200 in some embodiments. The exemplary interface 200 may comprise multiple fields to receive queries (e.g., fields 204, 206, and 208) as well as a visualization area 210 to display graphs (e.g., networks of nodes and edges generated by the user interface module 116).

In various embodiments, multiple queries may be received simultaneously from the fields 204, 206, and/or 208. The query module 112 may provide the queries to the database module 124 and/or process the queries simultaneously or near simultaneously. In some embodiments, query result sets are retrieved and/or identified. Each query result set may be related to a different query. The relationship module 114 may identify subsets (if any) between the query result sets and the user interface module 116 may generate nodes (e.g., for each query result set) and edges between the nodes (e.g., representing subsets or relationships between or among the nodes). Nodes and edges may be subsequently rendered and/or displayed on a display by the graphic module 106 in the visualization area 210.

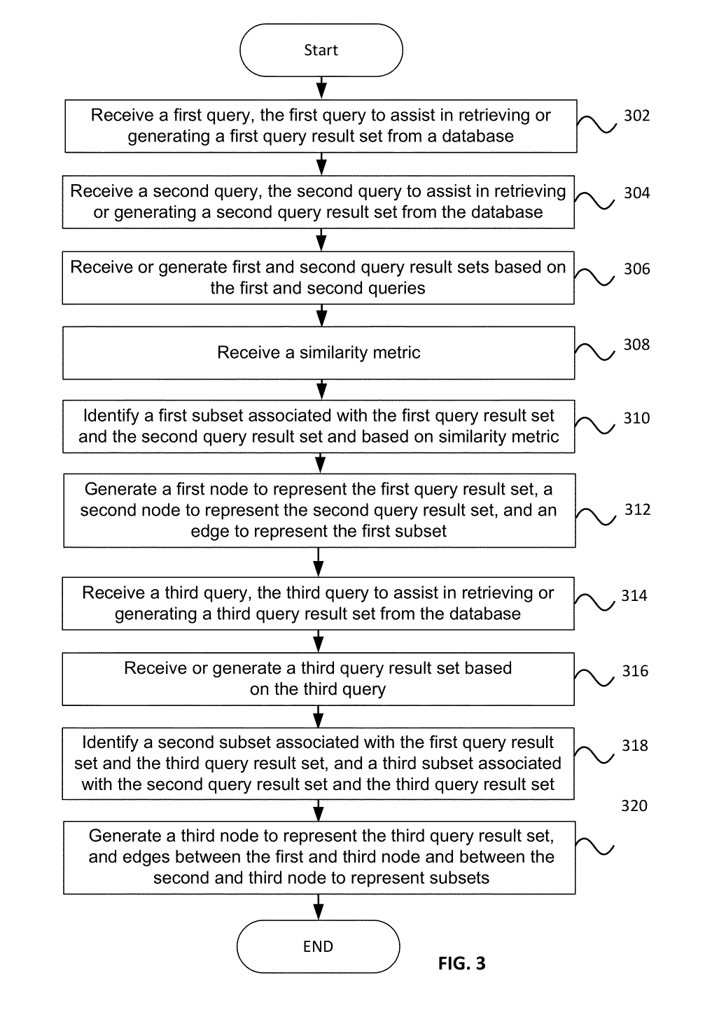

FIG. 3 is a flowchart for providing a visualization depicting relationships between query result sets in some embodiments. In step 302, the query module 112 may receive a first query. The first query may assist in retrieving or generating information relevant to the first query (i.e., a first query result set) from the database(s) 122. In step 304, the query module 112 may receive a second query. The second query may assist in retrieving or generating information relevant to the first query (i.e., a first query result set) from the database(s) 122.

The query module 112 may provide the first and second queries to a database module 124. In some embodiments, the query module 112 may perform all or part of the functions of the database module 124.

In some embodiments, the query module 112 may generate new queries based on the first and/or second queries. The query module 112 may, in some embodiments, convert queries from one format or state to another (e.g., generate a new query based on a natural language query received from a user). The queries may be provided or used to generate query result sets simultaneously or near simultaneously.

In step 306, the query module 112 may receive or generate a first query result set based on the first query and a second query result set based on the second query. The query result sets include information from a database relevant to the queries.

In step 308, the query module 112 may receive a similarity metric (i.e., a metric to measure similarity). The similarity metric may be provided or identified by a user or application. In some embodiments, the visualization module 110 provides one or more similarity metrics as options for the user or application.

In step 310, the relationship module 114 identifies a first subset associated with the first query result set and the second query result set based on the similarity metric(s). In various embodiments, the relationship module 114 generates a relationships query (e.g., a meta-query) based on the similarity metric(s) and based on the first and second query result sets. The relationships query may be provided to the database module 124 which may identify a subset to provide to the relationship module 114. The subset includes information relevant to the relationships query. In one example, the database module 124 identifies, based on the metric, information that may be similar to both first and second query result sets. The subset may include the identified information.

For example, the first query result set may include all email of a corporate CEO while a second query result set includes all email identifying a secret project by project name. The first query result set may include or identify all email of the CEO. The second query result set may include or identify all email that qualifies the condition. To determine the subset, the database module 124 (or the relationship module 114) may examine the email of the first query result set and the email of the second query result set to determine if there are any email that belong to both query result sets. The database module 124 (or the relationship module 114) may generate a subset including or identifying email that belong to both query result sets.

In another example, the first query result may include a list of names of recurring customers over a particular time period while the second query result may include a list of top selling products. The relationship module 114 may generate a relationships query based on the first and second queries to instruct the database module 124 to search information related to any customers in the list of names of recurring customers to identify those that have purchases a top selling product listed in the second query result set. Those skilled in the art will appreciate that the information within the subset may not necessarily be within either query result set. The information within the subset was related, however, to information within both query result sets.

In step 312, the user interface module 116 may generate a first node to represent the first query result set, a second node to represent the second query result set, and an edge between the first and second nodes to represent the first subset. The nodes and edge may be rendered and/or displayed to a user or application.

In some embodiments, a user or application may select either node to identify any amount of information of the related query result set. Similarly, the user may select the edge to identify any amount of information of the subset. Information related to the query result set or subset may displayed in any number of ways such as, but not limited to, lists, tables, views, dashboard views, or visualizations.

In step 314, the query module 112 may receive a third query. The third query may assist in retrieving or generating information relevant to the third query (i.e., a third query result set) from the database(s) 122. In step 316, the query module 112 may provide the third query to a database module 124 and receive the third query result set. In step 318, the relationship module 114 identifies a second subset associated with the first query result set and the third query result set based on the similarity metric(s). Further, the relationship module 114 may identify a third subset associated with the second query result set and the third query result set based on the similarity metric(s). In various embodiments, the relationship module 114 generates a relationships query based on the similarity metric(s) and based on the first and third query result sets as well as a relationships query based on the similarity metric(s) and based on the second and third query result sets.

In step 320, the user interface module 116 may generate a third node to represent the third query result set, an edge between the first and third nodes to represent the second subset, and an edge between the second and third nodes to represent the third subset.

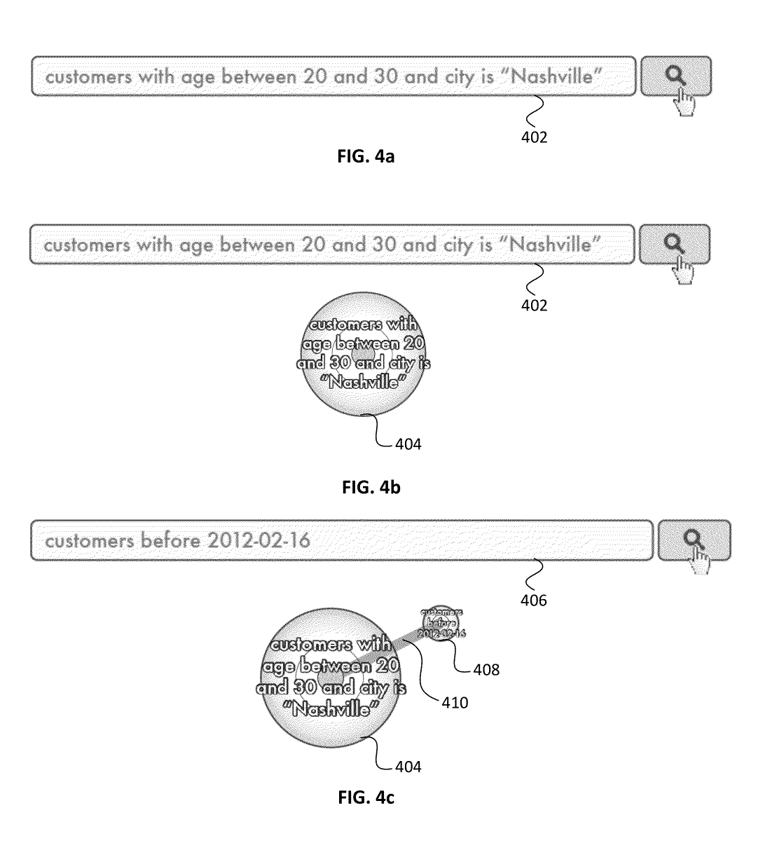

FIG. 4a depicts an exemplary query field 402 in some embodiments. In various embodiments, the user interface module 116 generates the query field 402. In this example, the query field 402 receives a query “customer with age between 20 and 30 and city is ‘Nashville.’” Once the query is received, the query module 112 may provide the query to a database module 124. The database module 124 may provide a query result set to the query module 112. The query result set may comprise or represent information identified as being responsive to the query from query field 402.

FIG. 4b depicts an exemplary node 404 which represents the query result set for the query “customer with age between 20 and 30 and city is ‘Nashville’” in some embodiments. In various embodiments, the user interface module 116 generates the graphic for the node 404 to be displayed representing the query result set. Although the graphic is displayed as a round node 404 in FIG. 4b, the graphic may be any (or include any combination of) size, shape, color, animation, or the like. In some embodiments, the size of the node 404 is based on the number of records and/or amount of information related to the query result set associated with the query from the query field 402.

FIG. 4c depicts exemplary query field 406 as well as exemplary nodes 404 and 408 coupled by an edge 410 in some embodiments. The query field 406 may be the same query field as or different query field than the query field 402 depicted in FIGS. 4a and 4b. In this example, a second query is received after the node 404 of the first query is depicted. The second query within the query field 406 is “customers before 2012-02-16.” In one example, the query module 112 may receive the query input into the query field 406 and may receive a query result set based on information retrieved or identified from the database(s) 122 responsive to the query. In this example, “customers before 2012-02-16” may retrieve records or representative information about records regarding individuals who where customers before 2012-02-16. The user interface module 116 may generate a second node 408 to represent this query's query result set.

In this example, the number of members of the second query result set is fewer in number than the number of members of the first query result set. As such, the user interface module 116 may depict the node 408 as being comparatively smaller than the node 404.

In various embodiments, the relationship module 114 may identify a subset between the two query result sets. In some embodiments, the relationship module 114 assesses the two query result sets to determine common information to generate the subset. In some embodiments, the relationship module 114 may generate a new query to request the database module 214 retrieve all or some information regarding the subset of the two query result sets.

The subset may represent any information that is related between the two query result sets. In some embodiments, the subset indicates individuals who are responsive to both queries (e.g., the subset indicates those people who are both “customers with age between 20 and 30 and their city is “Nashville” and have been “customers before 2012-02-16”). The subset may be based on any relationship; for example, the subset may include only those people who are not in members of either query result set. In this example of FIG. 4c, the subset indicates individuals who are members of both query result sets.

The subset is depicted by the user interface module 116 as an edge. The edge is a line coupling the first node 404 and the second node 408 and represents those individuals of the database(s) 122 that are members of both query result sets. The edge is depicted in FIG. 4c as a line but may be any shape (e.g., an arc) coupling the two nodes 404 and 408. The size of the edge may represent the number of members of the subset.

In various embodiments, a user may select the subset to view representations and/or data from the database(s) 122 related to the subset. In one example, a user may select and/or activate the selection (e.g., click on the edge 410) to view and/or select members or representations of the members of the subset. The members of the subset may be depicted in any number of different ways (e.g., graphically as a line graph, graphically as a pie graph, textually in table, or any dashboard visualization). Similarly, a user may select and/or activate either node 404 or 408 (e.g., click on the node 404 or 408) to view and/or select members or representations of the members of the nodes 404 or 408. The members of the nodes 404 or 408 may be depicted in any number of different ways (e.g., graphically as a line graph, graphically as a pie graph, textually in table, or the like). In some embodiments, a user may view information regarding a query result set by selecting a node in order to generate new queries directed to the query result set.

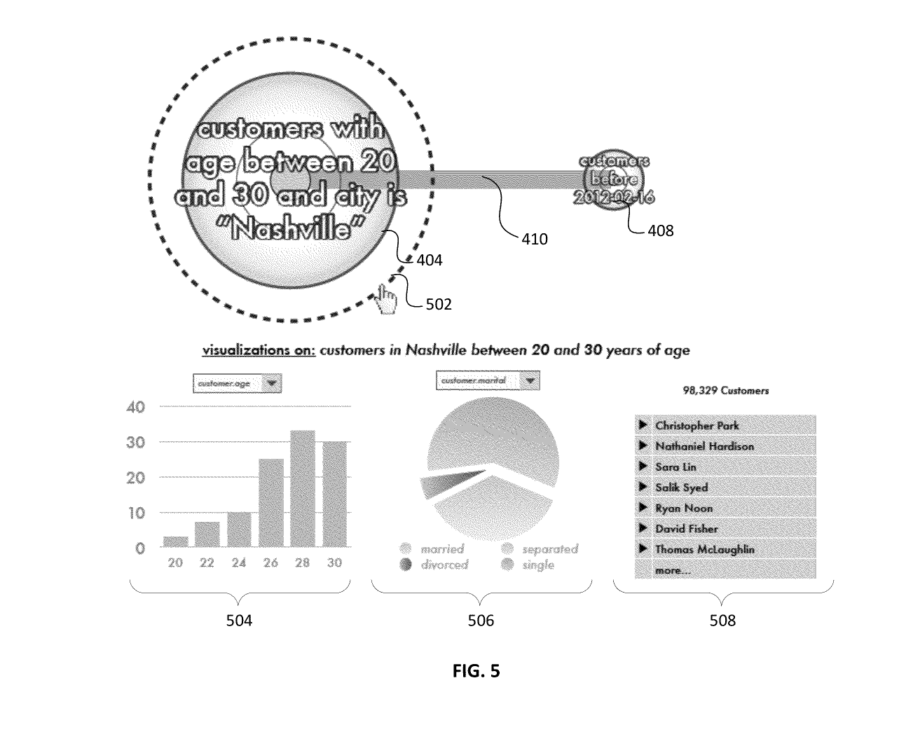

FIG. 5 is a graph depicting selection of a node to generate views in some embodiments. A user or an application may select any number of nodes, edges, or combination of node(s) and edge(s). In this example, node 404 is selected. The selection is identified by dotted line 502. In various embodiments, any data structure or graph may depict information associated with query result sets that are related to selected node(s) and/or edge(s). In one example, all information associated with the query result set(s) may be displayed in a table or other data structure. In some embodiments, a user may select a node to view information related to the related query result set in any number of ways, including, for example but not limited to, bar chart 504, pie graph 506, and/or data structure 508.

In some embodiments, a user may select a manner in which they wish to view information and/or the information that they wish to view (or visualize). For example, bar graph 504 may display a bar graph representing all or some of the query result set associated with node 404. In this example, the user may select node 504 and configure the user interface to display bar graph 504 to display customer age of the query result set associated with node 404.

In another example, pie graph 506 may display a pie graph representing all or some for the query result set associated with node 404. In this example, the user may select node 404 and configure the user interface to display pie graph 506 to display customer marital status of the query result set associated with node 404.

In a further example, data structure 508 may display a list or table representing all or some for the query result set associated with node 404. In this example, the user may select node 404 and configure the user interface to display data structure 508 to display customer names of the query result set associated with node 404.

Those skilled in the art will appreciate that the bar graph 504, the pie graph 506, and/or the data structure 508 may depict information associated with any selected node(s) or edge(s) (e.g., associated with query result set(s) associated with any selected(s) or subsets associated with any edge(s)).

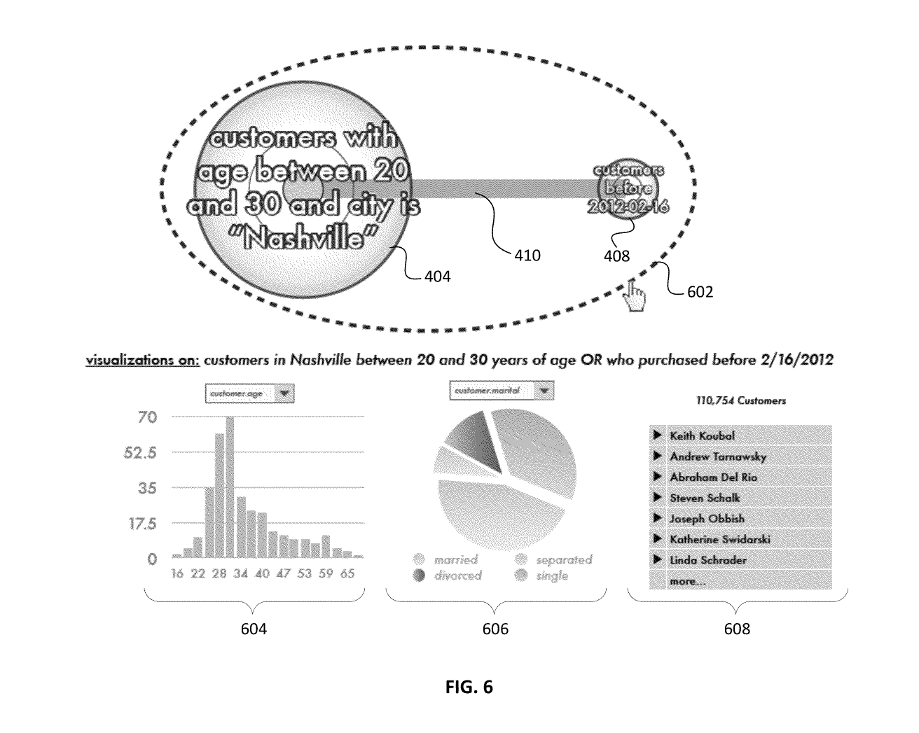

FIG. 6 is a graph depicting selection of two nodes 404 and 408 and an edge 410 to generate views in some embodiments. As discussed herein, a user or an application may select any number of nodes, edges, or combination of node(s) and/or subsets related to selected edge(s). In this example, node 404, node 408, and edge 410 are selected. The selection is identified by dotted line 602. In one example, a user may group the nodes and edge together for selection (e.g., by clicking and dragging a cursor to display a box or other object over the desired elements). In various embodiments, any data structure or graph may depict information associated with query result sets that are related to selected node(s) and/or subsets related to selected edge(s). In one example, all information associated with the query result set(s) may be displayed in a table or other data structure.

In some embodiments, a user may select a manner in which they wish to view information and/or the information that they wish to view (or visualize). For example, bar graph 604 may display a bar graph representing all or some of the query result sets associated with node 404, node 408, and edge 410. In this example, the user may select node 404, node 408, and edge 410 and configure the user interface to display bar graph 604 to display customer age of the query result sets associated with node 404, node 408, and edge 410.

In another example, pie graph 606 may display a pie graph representing all or some for the query result sets associated with node 404, node 408, and edge 410. In this example, the user may select node 404, node 408, and edge 410, and configure the user interface to display pie graph 606 to display customer marital status of the query result sets associated with node 404, node 408, and edge 410.

In a further example, data structure 608 may display a list or table representing all or some for the query result sets associated with node 404, node 408, and edge 410. In this example, the user may select node 404, node 408, and edge 410 and configure the user interface to display data structure 608 to display customer names of the query result sets associated with node 404, node 408, and edge 410.

Those skilled in the art will appreciate that the bar graph 604, the pie graph 606, and/or the data structure 608 may depict information associated with any selected node(s) or edge(s) (e.g., associated with query result set(s) associated with any selected(s) or subsets associated with any edge(s)).

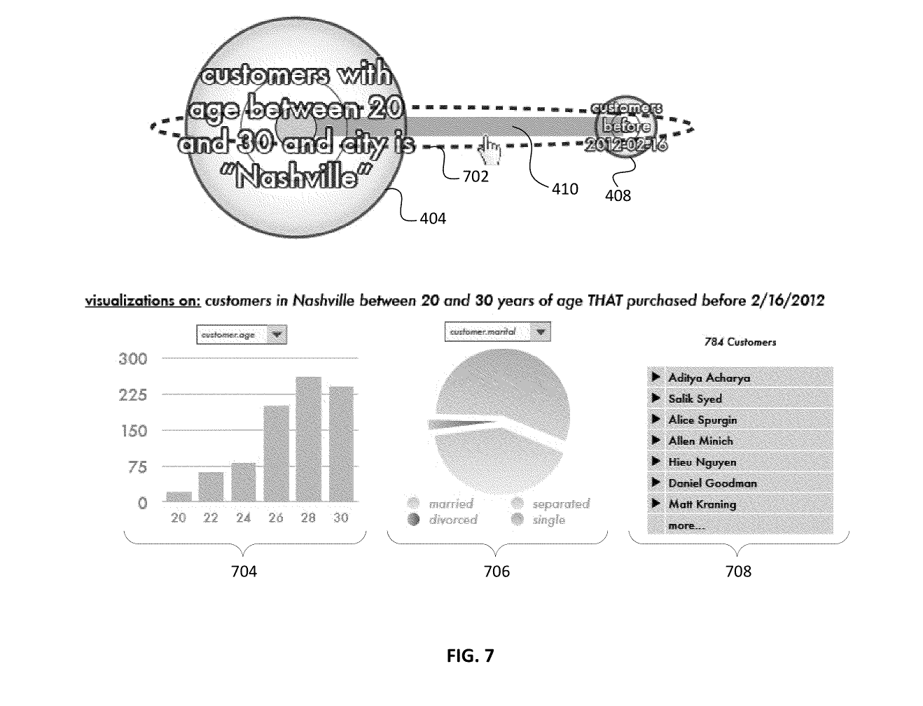

FIG. 7 is a graph depicting selection of an edge 410 to generate views in some embodiments. In this example, edge 410 is selected. The selection is identified by dotted line 702. In various embodiments, any data structure or graph may depict information associated with query result sets that are related to selected node(s) and/or subsets related to selected edge(s). In one example, all information associated with the subset(s) may be displayed in a table or other data structure.

In some embodiments, a user may select a manner in which they wish to view information and/or the information that they wish to view (or visualize). For example, bar graph 704 may display a bar graph representing all or some of the subset associated with edge 410. In this example, the user may select edge 410 and configure the user interface to display bar graph 704 to display customer age of the subset associated with edge 410.

In another example, pie graph 706 may display a pie graph representing all or some for the subset associated with edge 410. In this example, the user may select edge 410 and configure the user interface to display pie graph 706 to display customer marital status of the subset associated with edge 410.

In a further example, data structure 708 may display a list or table representing all or some for the subset associated with edge 410. In this example, the user may select edge 410 and configure the user interface to display data structure 708 to display customer names of the subset associated with edge 410.

Those skilled in the art will appreciate that the bar graph 704, the pie graph 706, and/or the data structure 708 may depict information associated with any selected node(s) or edge(s) (e.g., associated with query result set(s) associated with any selected(s) or subsets associated with any edge(s)).

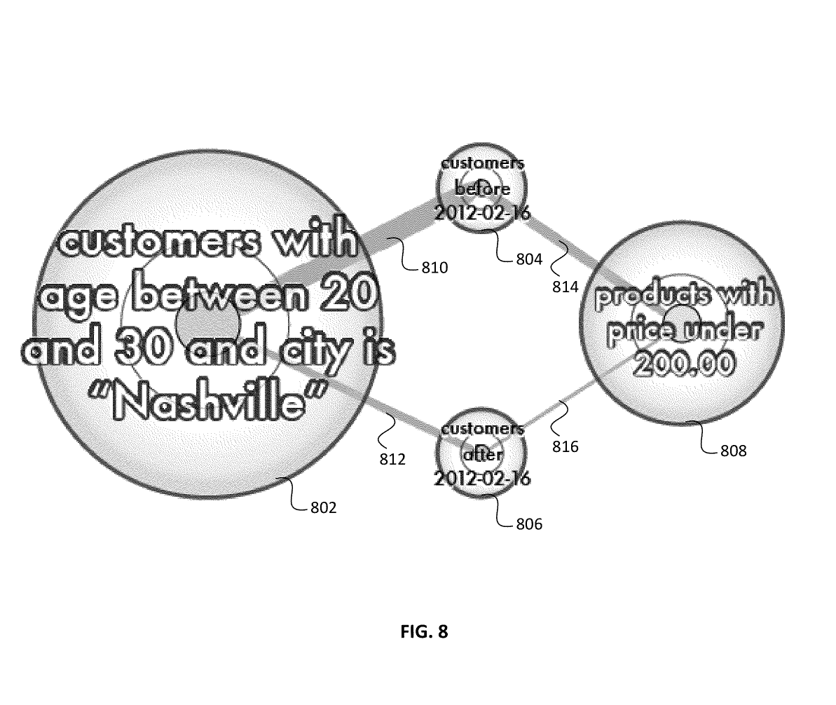

FIG. 8 depicts a graph depicting how queries across different data types can be joined to depict relationships in some embodiments. Graph 800 depicts nodes 802, 804, 806, and 808. Node 802 represents a query result set associated with query “customers with age between 20 and 30 and city is ‘Nashville.’” Node 804 represents a query result set associated with query “all customers before 2012-02-16” while node 806 represents a query result set associated with query “all customers after 2012-02-16.” Edge 810 represents a subset based on the query result sets associated with nodes 802 and 804. Similarly, edge 812 represents a subset based on the query result sets associated with nodes 802 and 806.

In this example, nodes 804 and 806 may represent query result set associated with one or more queries of a database (e.g., database(s) 122). If the one or more queries were directed to the query result set represented by node 802, then node 802 may have split into nodes 804 and 806. The splitting and merging of nodes is discussed herein.

Those skilled in the art will appreciate that each node 802, 804, and 806 may represent a different query on the same database(s). There may be no edge between nodes 804 and 806 because the queries related to the nodes may be mutually exclusive (i.e., the query result sets related to the nodes 804 and 806 do not share any members or information).

Those skilled in the art will appreciate that node 808 is associated with a query of a different data type than the queries associated with other nodes. For example, the query associated with node 808 (i.e., “products with price under 200.00”) is directed towards products while the queries associated with nodes 802, 804, and 806 are directed to customers. The data of the queried database(s) (e.g., database(s) 122), however, may contain information associating customers with product pricing. As a result, since the query result sets associated with nodes 804 and 808 share at least some information (e.g., all customers before 2012-02-16 includes customers who purchased products with prices under 200.00), the relationship module 114 may identify the subset and the user interface module 116 may generate the edge 814 representing the subset. Similarly, since the query result sets associated with nodes 806 and 808 share at least some information (e.g., all customers after 2012-02-16 includes customers who purchased products with price under 200.00), the relationship module 114 may identify the subset and the user interface module 116 may generate the edge 814 representing the subset.

In some embodiments, the relationship module 114 may identify a subset between the query result set associated with node 802 and the query result set associated with node 808. In some embodiments, a query may be directed to the query result sets of 804 and 806 (e.g., by selecting query result sets 804 and 806) and, as a result, the relationship module 114 may identify subsets among nodes 804, 806, and 808. In this example, since the query result set for node 802 were not included for the query associated with node 808, the user interface module 116 may not generate an edge between nodes 802 and 808.

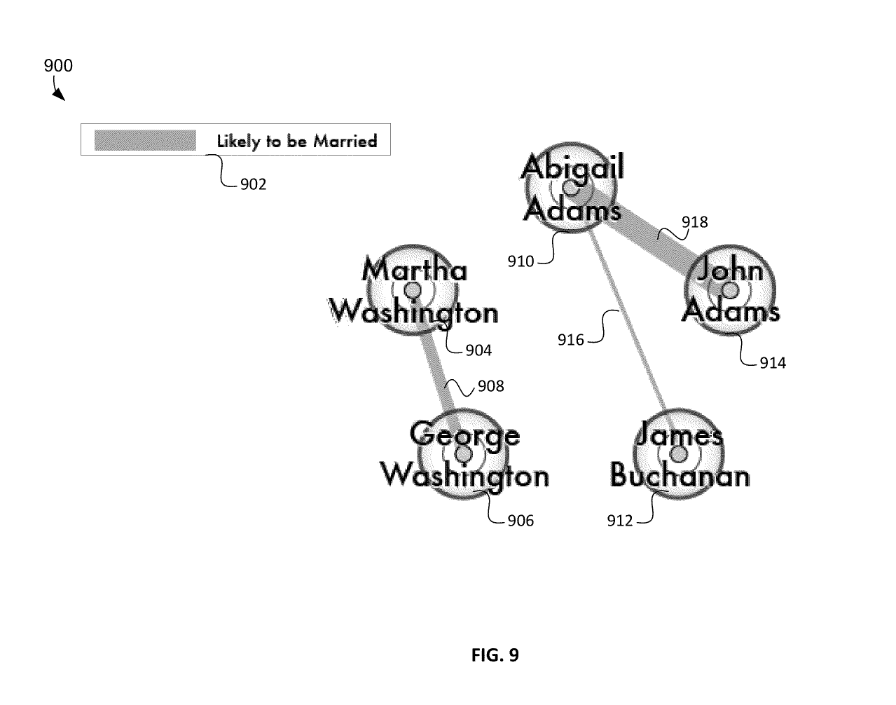

FIG. 9 is a graph depicting edges generated based on affinity calculations in some embodiments. Graph 900 depicts nodes 904, 906, 910, 912, and 914. Node 904 may represent a query result set associated with a query regarding Martha Washington. Node 906 may represent a query result set associated with a query regarding George Washington. Node 910 may represent a query result set associated with a query regarding Abigail Adams. Node 912 may represent a query result set associated with a query regarding John Adams. Node 914 may represent a query result set associated with a query regarding James Buchanan.

In some embodiments, there may be no related information between query result sets and, as a result, one or more nodes may not be coupled to any other nodes by an edge (e.g., the relationship module 114 determined that the subsets between and among nodes have 0 members). In various embodiments, a user or application may request that one or more edges not be displayed or hidden in the graph to allow one or more other edges to be more apparent (e.g., new queries regarding subsets of query result set(s) and/or the database(s) 122).

In one example, a user or application may provide a query directed to subsets between and/or among nodes 904, 906, 910, 912, and 914 (individually and in any combination). The query module 112 may provide a “subset” query (e.g., a relationships query or meta-query) to the relationship module 114 or the database module 124 which may identify or assist in identifying related subset(s) between and/or among nodes 904, 906, 910, 912, and 914 (individually and in any combination). In this example, the user or application provides a “subset” query for “likely to be married” (e.g., shown in legend 902) The relationship module 114 or the database module 124 may identify or assist in identifying related subset(s) between and/or among nodes 904, 906, 910, 912, and 914 (individually and in any combination).

In this example, subsets of information may be identified based the query of “likely to be married” directed to the query result sets of nodes 904, 906, 910, 912, and 914. Because, some information identified by the “likely to be married” query is related to query result sets associated with nodes 904 and 906, a subset between the nodes is identified and the user interface module 116 may generate edge 908 between nodes 904 and 906.

Similarly, because some information identified by the “likely to be married” query is related to query result sets associated with nodes 910 and 912 as well as query result sets associated with nodes 910 and 914, subsets between the nodes is identified and the user interface module 116 may generate edge 916 between nodes 910 and 912 and generate edge 918 between nodes 910 and 914. Since there is likely significant information relevant to the node 910 representing Abigail Adams and the node 914 representing John Adams being likely to be married, the edge 918 may be thick compared to edge 916. Comparatively, there is likely less information relevant to the node 910 representing Abigail Adams and the node 912 representing James Buchanan being likely to be married; as a result, the edge 916 may be thin. In other words, there is more information associated with subset represented by edge 918 than the amount of information associated with the subset represented by edge 916.

Those skilled in the art will appreciate that users may hide or display any number of edges and/or nodes in a graph.

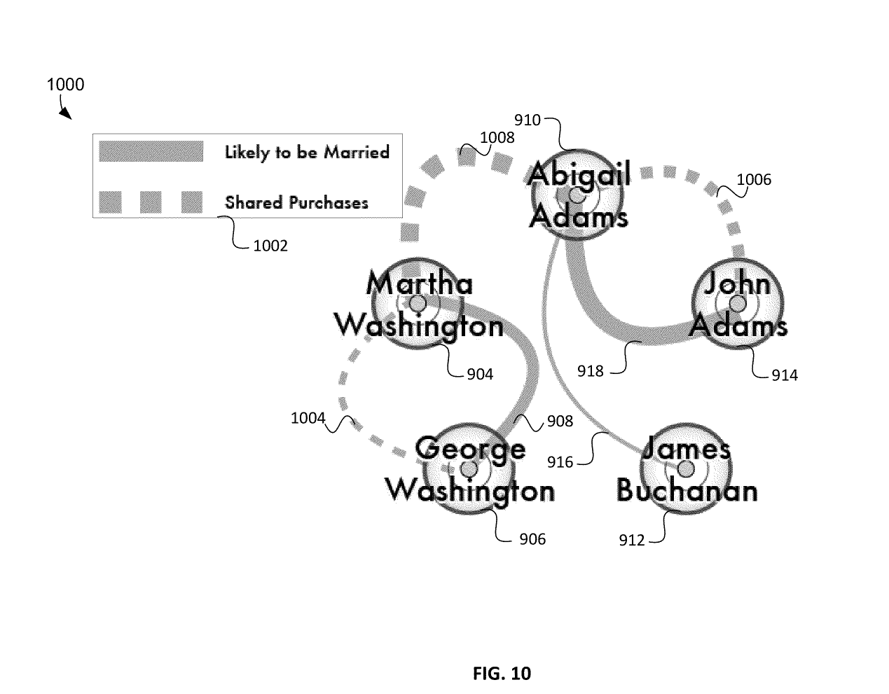

FIG. 10 is a graph depicting multiple edges in some embodiments. Graph 1000 is similar to Graph 900 except for the addition of edges and an additional query. In some embodiments, a user or application may provide any number of queries directed to subsets between and/or among nodes 904, 908, 910, 912, and 914 (individually and in any combination) which may result in any number of edges between and/or among nodes.

Multiple edges between nodes may or may not be distinguished from each other. In various embodiments, edges that represent subsets based on different queries may be differentiated based on line texture (e.g., dotted or dashed lines), color, animation (e.g., moving or glowing lines) or any other number of ways.

For example, the query module 112 may provide multiple “subset” queries to the relationship module 114 and/or the database module 124 which may identify or assist in identifying related subset(s) between and/or among nodes 904, 908, 910, 912, and 914 (individually and in any combination). In this example, the user or application provides a first “subset” query for “likely to be married” and a second “subset” query for “shared purchases” (e.g., shown in legend 1002). The relationship module 114 or the database module 124 may identify or assist in identifying related subsets between and/or among nodes 904, 908, 910, 912, and 914 (individually and in any combination) based on the queries.

In this example, as discussed regarding FIG. 9, subsets of information may be identified based the query of “likely to be married” directed to the query result sets of nodes 904, 908, 910, 912, and 914. Similarly, subsets of information may be identified based on the query “shared purchases” directed to the query result sets of nodes 904, 908, 910, 912, and 914. Because, some information identified by the “likely to be married” query is related to query result sets associated with nodes 904 and 906, a subset between the nodes is identified and the user interface module 116 may generate edge 908 between nodes 904 and 906. Similarly, since some information identified by the “shared purchases” query is related to query result sets associated with nodes 904 and 906, a subset between the nodes is identified and the user interface module 116 may generate edge 1004 between nodes 904 and 906. Edge 908 and edge 1004 may be differentiated in any number of ways. For example, as depicted in FIG. 10, the second edge may be depicted as a dashed line between nodes 904 and 906.

Similarly, because some information identified by the “likely to be married” query is related to query result sets associated with nodes 910 and 912 as well as query result sets associated with nodes 910 and 914, subsets between the nodes is identified and the user interface module 116 may generate edge 916 between nodes 910 and 912 and generate edge 918 between nodes 910 and 914. Since there is likely significant information relevant to the node 910 representing Abigail Adams and the node 914 representing John Adams being likely to be married, the edge 918 may be thick compared to edge 916.

Similarly, since some information identified by the “shared purchases” query is related to query result sets associated with nodes 910 and 914, a subset between the nodes is identified and the user interface module 116 may generate edge 1006 between nodes 910 and 914. Edge 1006 may be depicted similar to edge 1004. Unlike nodes 910 and 914, however, there may not be any information regarding “shared purchases” based on query result sets related to node 910 and 912. As such, the user interface module 116 may not depict a second edge between 910 and 912.

Interestingly, however, the database apparently does contain information indicating a relationship between information associated with query result set for nodes 904 and 910 (e.g., there is some information in the database(s) 122 indicating that Martha Washington shared purchases with Abigail Adams). Based on this relationship, the user interface module 116 may generate an edge 1008 associated with the “shared purchases” query between nodes 904 and 910.

In some embodiments, a user or application may select how different edges are depicted (e.g., allowing for the choice of texture, color, animation of any edge or combination of edges or based on query). Similarly, in some embodiments, a user or application may select how different nodes or combination of edges and nodes are depicted (e.g., allowing for the choice of texture, color, animation of any edge or combination of nodes or based on query).

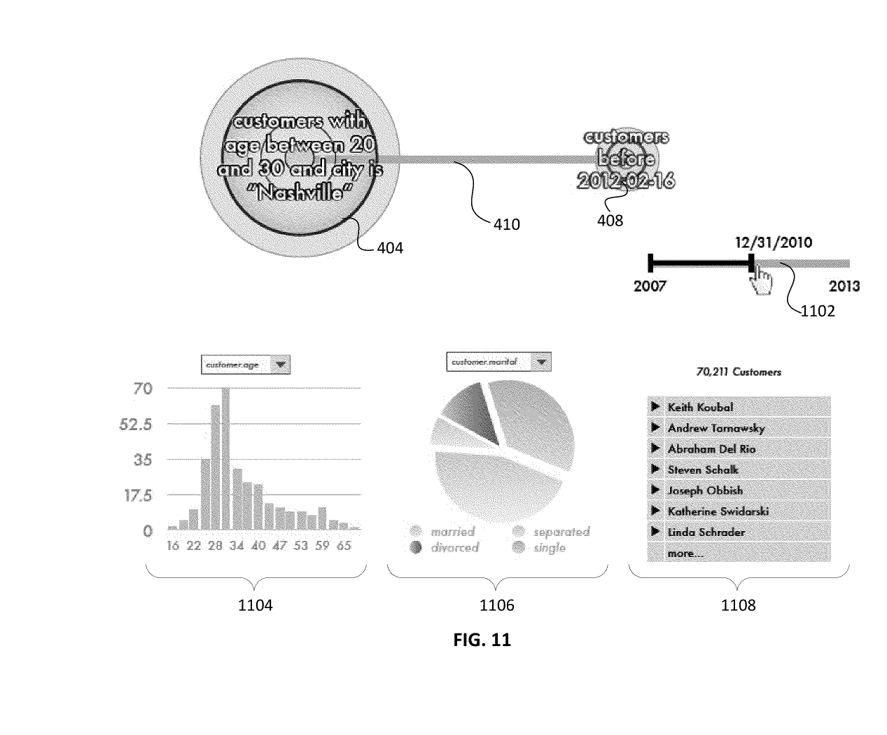

FIG. 11 is a graph depicting filtering in some embodiments. Filters may be applied to nodes and/or edges. In various embodiments, a filter may perform a query on a query result set and/or a subset. Once a filter is engaged, information from the selected query result set may be affected (e.g., removed or hidden) in response to the filter. In various embodiments, the relationship module 114 applies the filter (e.g., applies the query corresponding to the future) on one or more query result sets (e.g., the query result sets corresponding to all or some of the nodes of a graph). In some embodiments, all or some of the filter is applied by the database module 124 and the results are provided to the query module 112.

In some embodiments, filtering is another query that may get “AND”ed with each node on a graph. In some embodiments, filtering is another query that may get “AND”ed with selected nodes. Those skilled in the art will appreciate that the filtering query may have any effect on existing query result set associated with one or more nodes of a graph depending on the filtering query.

In the example of FIG. 11, the slider bar 1102 may indicate a filter to remove or hide data from query result sets for customers after 12/31/2010. The data may be removed or hidden from query result sets associated with nodes 404 and 408. In FIG. 11, the gray region around each node represents the change in size of the nodes after the filter (e.g., as depicted by slider bar 1102) is applied. In this example, the size of the nodes 404 and 408 are representative of the size of the associated query result set (e.g., the number of separate entries and/or amount of data of each query result set).

Those skilled in the art will appreciate that changes to the query result sets of any node in a graph may cause the relationship module 114 to apply the filter to previously determined subsets and/or re-determine subsets (e.g., identify new subsets of filtered query result set). The user interface module 116 may generate on the display a new edge based on the new subset while removing or hiding the previous edge.

In some embodiments, if the filter is applied and a user selects a node (e.g., node 404), data consisting of or representing filtered data from the selected node's query result set may be displayed. For example, bar graph 1104 may display a bar graph representing all or some of the query result set associated with node 404. In this example, the user may select node 404 and configure the user interface to display bar graph 1104 to display customer age of the filtered query result set associated with node 404.

In another example, pie graph 1106 may display a pie graph representing all or some for the filtered query result set associated with node 404. In this example, the user may select node 404 and configure the user interface to display pie graph 1106 to display customer marital status of the filtered query result set associated with node 404.

In a further example, data structure 1108 may display a list or table representing all or some for the query result set associated with node 404. In this example, the user may select node 404 and configure the user interface to display data structure 1108 to display customer names of the filtered query result set associated with node 404.

Those skilled in the art will appreciate that the bar graph 1104, the pie graph 1106, and/or the data structure 1108 may depict information associated with any selected node(s) or edge(s) (e.g., associated with query result set(s) associated with any selected(s) or subsets associated with any edge(s)).

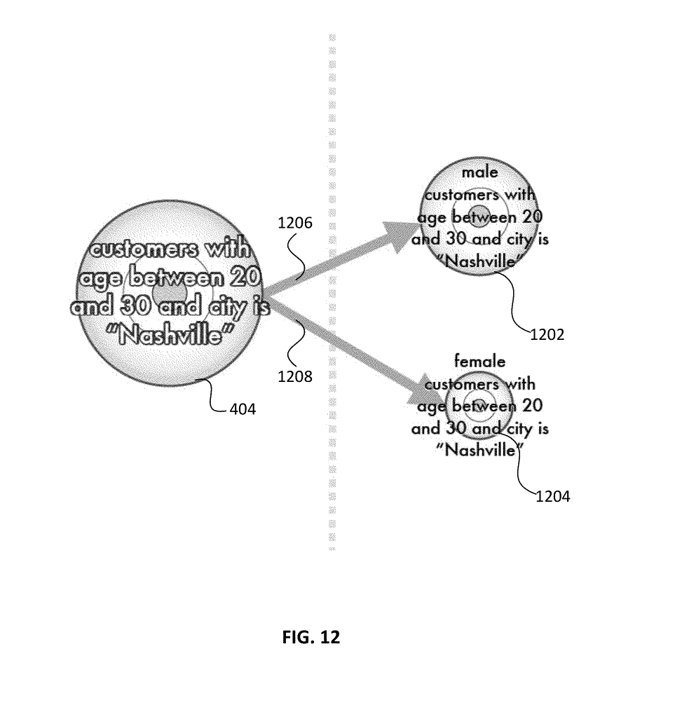

FIG. 12 depicts splitting a node 404 into two individual nodes 1202 and 1204 in some embodiments. In various embodiments, any number of queries (e.g., one or more filters) may be applied to the query result set associated with a node. As a result of the application of the quer(ies), the node may be split.

For example, a graph may display node 404 to a user on a display. The user may select the node 404 and request an application of another query on the node's associated query result set to split information related to the query result set into two query result sets based on the new query. For example, node 404's query result set is associated with the query “customers with age between 20 and 30 and city is ‘Nashville.’” The user may select node 404 and apply a new query on the node's query result set to create two new query result sets. In this example, the first new query result set may include male customers between 20 and 30 and city is “Nashville” while the second new query result set may include female customers between 20 and 30 and city is “Nashville.”

After application of the new query on the query result set associated with node 404, the user interface module 116 may generate nodes 1202 and 1204 and remove (or hide) node 404. In various embodiments, arrows 1206 and 1208 indicate the new nodes and are not edges and/or may not be displayed to the user in the user interface. Node 1202 may be associated with the first new query result set and node 1204 may be associated with the second query result set.

After node 404 is split, the relationship module 114 may identify, in some embodiments, subsets between either of the new nodes (e.g., nodes 1202 and 1204) and any other previously determined query result sets (e.g., represented by nodes other than node 404) and the user interface module 116 may generate edges between any new node and the other nodes based on the subsets.

Although FIG. 12 depicts node 404 being completely split into two new nodes 1202 and 1204, those skilled in the art will appreciate that node 404 may be split in any number of ways. A user may apply a query on the query result set associated with node 404 and, as a result, one or more new query result sets may be generated. In some embodiments, a smaller query result set associated with 404 may remain. As a result, multiple nodes including node 404 (e.g., node 404 being at a smaller size to represent the decrease in size of the associated query result set) or not including node 404 may be depicted after the split.

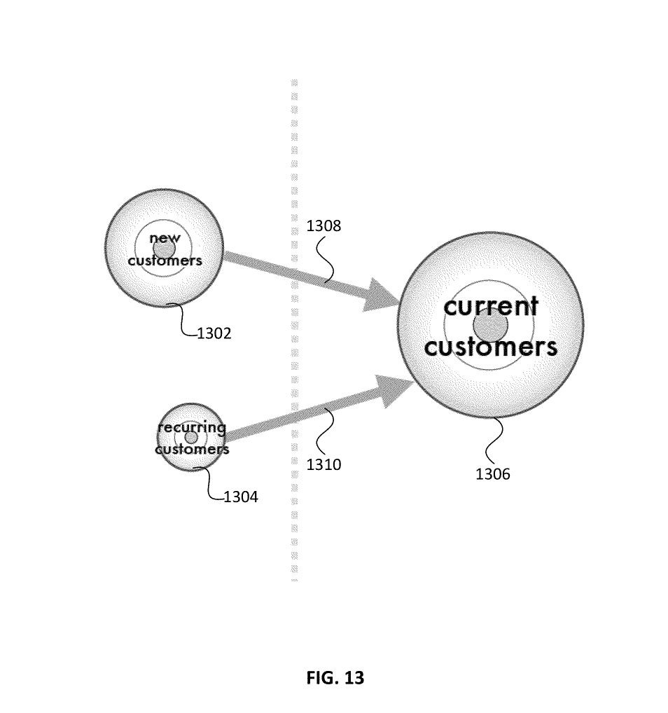

FIG. 13 depicts merging two individual nodes 1302 and 1304 into a single node 1306 in some embodiments. In various embodiments, any number of queries (e.g., one or more filters) may be applied to the query result sets associated with multiple nodes. As a result of the application of the quer(ies), nodes may be merged into a new node. Those skilled in the art will appreciate that queries may be merged together into more meaningful categories.

For example, a graph may display nodes 1302 and 1304 to a user on a display. The user may select the nodes 1302 and 1304 and request an application of another query on the nodes' associated query result sets to merge the query result sets into one query result set based on the new query. For example, nodes 1302 and 1304's query result sets is associated with the query “new customers” and “recurring customers,” respectively. The user may select nodes 1302 and 1304 and apply a new query on the nodes' query result sets to create one new query result set. In this example, the new query result set may include all “current customers” which includes the query result set for node 1302 (new customers) with the query result set for node 1304 (recurring customers).

After application of the query on the query result sets associated with nodes 1302 and 1304, the user interface module 116 may generate node 1306 and remove nodes 1302 and 1304. In various embodiments, arrows 1308 and 1310 indicate the new node and are not edges and/or may not be displayed to the user in the user interface. Node 1306 may be associated with the new query result set.

After nodes 1302 and 1304 are merged, the relationship module 114 may identify, in some embodiments, subsets between new node (e.g., node 1306) and any other previously determined query result sets (e.g., represented by nodes other than nodes 1302 and 1304 which are not depicted in FIG. 13) and the user interface module 116 may generate edges between any new node and the other nodes based on the new subsets.

Although FIG. 13 depicts nodes 1302 and 1304 as being completely merged into one new node 1306, those skilled in the art will appreciate that nodes 1302 and 1304 may be merged in any number of ways. A user may apply a query on the query result sets associated with nodes 1302 and 1304 and, as a result, one or more new query result sets may be generated. In some embodiments, a smaller query result set associated with nodes 1302 and 1304 may remain. As a result, multiple nodes including nodes 1302 and/or 1304 may be depicted after the merge. In another example, a new query may be applied to any number of nodes and only some of which may be merged. In a further example, a new query may be applied to any number of nodes which results in some nodes being merged while others are split.

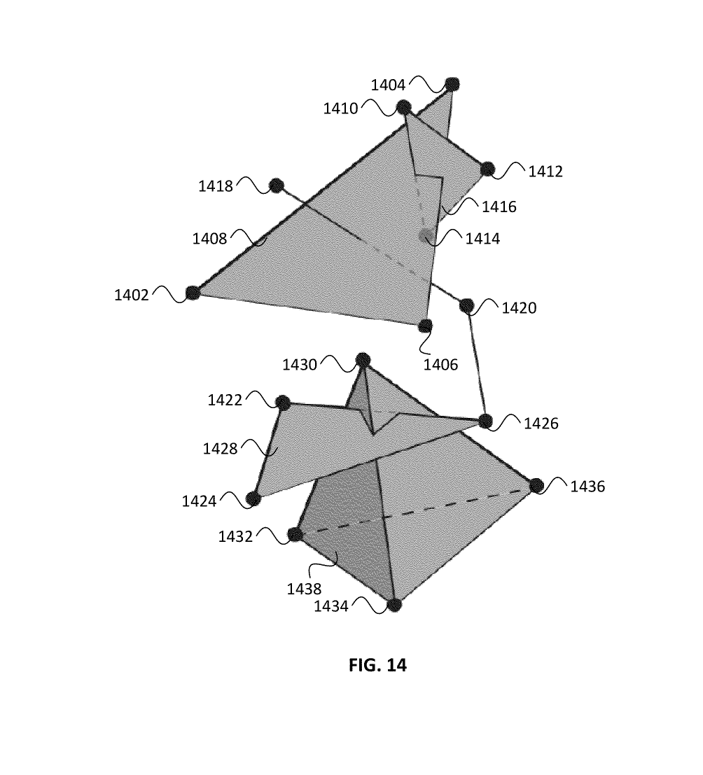

FIG. 14 depicts exemplary relationships between three or more nodes in a graph in some embodiments. In various embodiments, a subset may represent a relationship among any number of nodes (e.g., information shared among any number of nodes). When there is shared information related to query result sets of two nodes, the user interface module 116 may generate an edge between the two nodes. If there is shared information related to query result sets of three or more nodes, the user interface may depict the relationship with objects (e.g., triangles, trapezoids, boxes, pyramids, or the like). The number of sides of each object may be equal to the number of query result sets that share related information. The objects may be any number of dimensions (e.g., two dimensions such as a box or three dimensions such as a cube). The objects may also indicate shared information through shading. Those skilled in the art may consider an edge between two nodes as a two dimensional object.

For example, nodes 1402, 1404, and 1406 may be associated with different query result sets. The relationship module 114 may determine a subset of related information based on the query result set associated with node 1402, the query result set associated with node 1404, and the query result set associated with node 1406. The user interface module 116 may generate object 1408 (i.e., a shaded triangle) among the nodes 1402, 1404, and 1406 to represent the subset. A user may select the object 1408 to view or perform additional queries involving the subset.

In another example, nodes 1410, 1412, and 1414 may be associated with different query result sets. The relationship module 114 may determine a subset of related information based on the query result set associated with node 1410, the query result set associated with node 1412, and the query result set associated with node 1414. The user interface module 116 may generate object 1416 (i.e., a shaded triangle) among the nodes 1410, 1412, and 1414 to represent the subset. A user may select the object 1416 to view or perform additional queries involving the subset.

In various embodiments, different objects (e.g., object 1408 and 1416) may be depicted as intersecting each other without necessarily sharing information. In some embodiments, different objects (e.g., object 1408 and 1416) may be depicted as intersecting each other which may indicate sharing information.

Although some query result sets associated with some nodes may share information in a graph with two or more other query result sets associated with other nodes, not all nodes are associated with query result sets that share information or may share information with only one other query result set. For example, there is a subset for a query result set associated with node 1418 and a query result set associated with node 1420. Similarly, there is a subset for a query result set associated with node 1420 and a query result set associated with node 1426. The user interface module 116 may generate an edge between node 1418 and node 1420 as well as an additional edge between node 1420 and node 1426 based on the respective subsets.

In another example regarding the generation of objects, nodes 1422, 1424, and 1426 may be associated with different query result sets. The relationship module 114 may determine a subset of related information based on the query result set associated with node 1422, the query result set associated with node 1424, and the query result set associated with node 1426. The user interface module 116 may generate object 1428 (i.e., a shaded triangle) among the nodes 1422, 1424, and 1426 to represent the subset. A user may select the object 1428 to view or perform additional queries involving the subset.

In an example of an object with four sides, nodes 1430, 1432, 1434, and 1436 may be associated with different query result sets. The relationship module 114 may determine a subset of related information based on the query result set associated with node 1430, the query result set associated with node 1432, the query result set associated with node 1434, and the query result set associated with node 1436. The user interface module 116 may generate object 1438 (i.e., a shaded pyramid) among the nodes 1430, 1432, 1434, and 1436 to represent the subset. A user may select the object 1438 to view or perform additional queries involving the subset.

Those skilled in the art will appreciate that the objects may be generated in the user interface in any number of ways, including smaller two or three dimensional objects. In one example, a small triangle may be generated at or near any or all nodes associated with a subset with related query result sets.

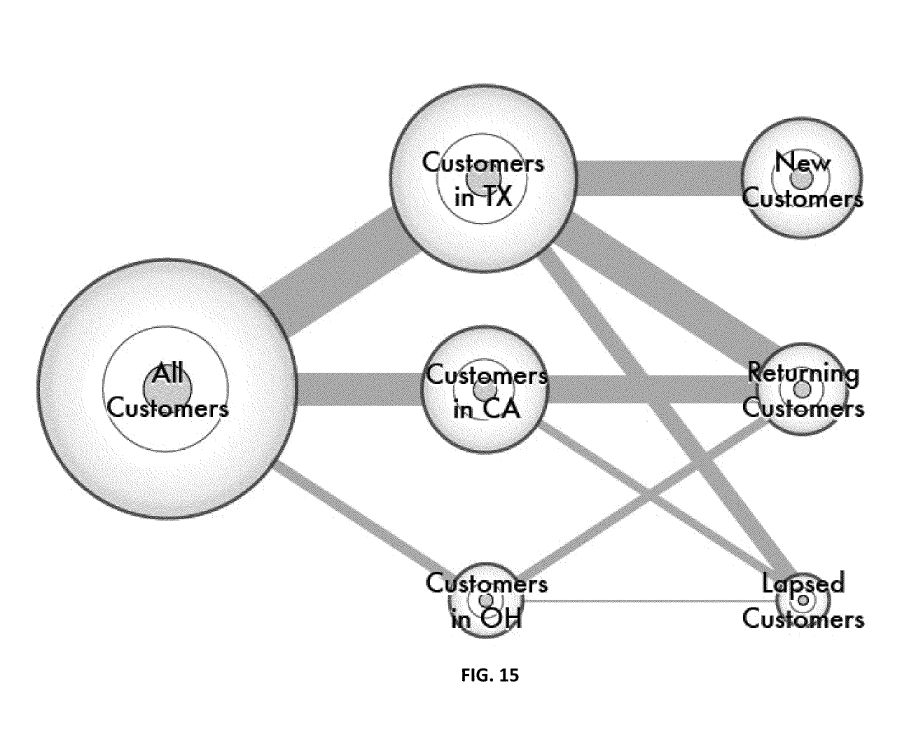

FIG. 15 depicts a graph of queries showing customer segmentation in some embodiments. FIG. 15 depicts seven nodes including “all customers,” “customers in Texas,” “customers in California,” “Customers in Ohio,” “new customers,” “returning customers,” and “lapsed customers.”

In one example, a customer may submit a query for “all customers.” The query module 112 may provide the query to a database module 124 via the communication network 118 and may receive a query result set from the database(s) 122 and/or the database module 124. The relationship module 114 may identify subsets of information based on related information of the query result set and any other previously existing query result set. If there are no subsets (e.g., all subsets have zero members), the user interface module 116 may generate a node representing the query result set without any edges.

A user or application may subsequently perform any number of queries on the query result set related to the “all customers” node and/or submit additional queries to the query module 112, database(s) 122, and/or database module 124. For example, a user may provide three queries to identify those customers in Texas, those customers in California, and those customers in Ohio. The user interface module 116 may generate nodes for each query as well as edges between the “All Customers” node and each of the newly generated nodes. The size of the nodes may indicate the amount of data associated with the related query (e.g., the size of the node for “all customers in Texas” may be larger than the size of the node for “all customers in Ohio” if there are more customers in Texas than in Ohio).

Subsequent queries may also be submitted to the query module 112. For example, the user or application may provide additional queries for “new customers,” “returning customers,” and “lapsed customers.” The three new queries may, for example, be limited to addressing the query result set for “customers in Texas,” “customers in California,” and “customers in Ohio” (which may be why there is no edge between “all customers” and the three new queries unless the user or application subsequently deleted or hid the edge in the graph). After the query result sets of the nodes for “customers in Texas,” “customers in California,” and “customers in Ohio” is retrieved and/or generated, the query module 112 provide to a database module 124 and/or process the new queries to generate or receive new query result sets.

In some embodiments, the new queries are directed to the query result sets of “customers in Texas,” “customers in California,” and “customers in Ohio.” The relationship module 114 may identify subsets between each new query result set and the query result sets of “customers in Texas,” “customers in California,” and “customers in Ohio.” The user interface module 116 may generate nodes for each of the new queries as well as edges based on the identified subsets. In this example, apparently all new customers are customers in Texas as shown by the large edge between the node “customers in Texas” and the node “new customers.” Apparently the query result sets associated with the “customers in Texas,” “customers in California,” and “customers in Ohio,” have at least some information associated with returning customers. Apparently, the most returning customers are customers in Texas, the next most returning customers are customers in California. The least number of recurring customers is from customers in Ohio. Like the query result set for “returning customers,” the “lapsed customer node shares at least some information with each of the “customers in Texas,” “customers in California,” and “customers in Ohio.”

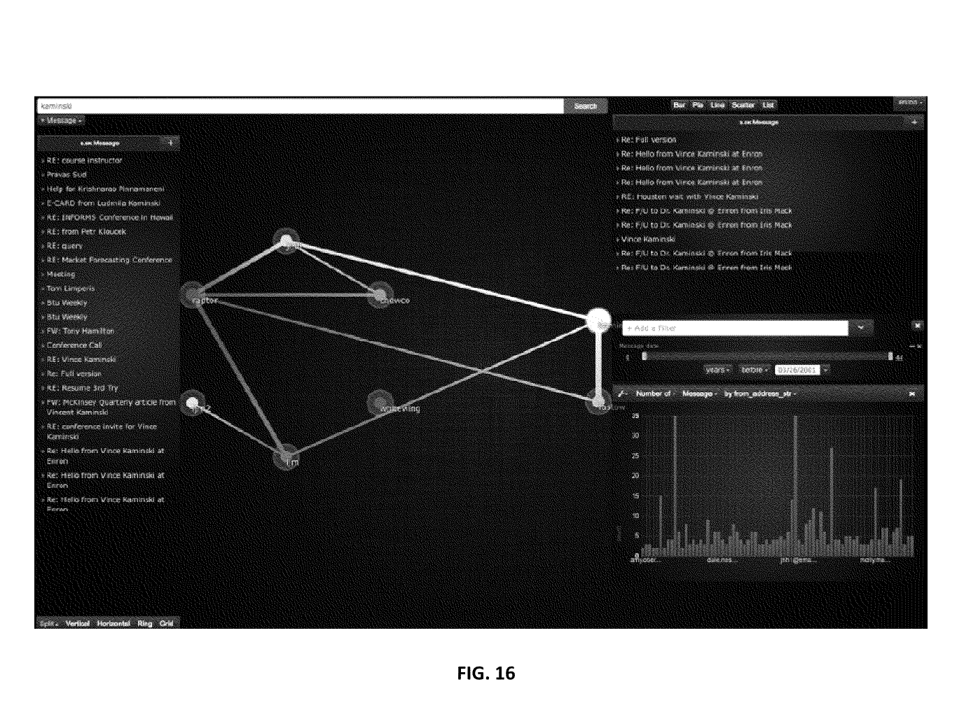

FIG. 16 is a display of a graph and a dashboard visualization of a bar graph in some embodiments. In some embodiments, colors, animations, textures, or the like may differentiate or provide additional information. The graph of FIG. 16 is an example of a user interface showing patters in a dataset of email messages.

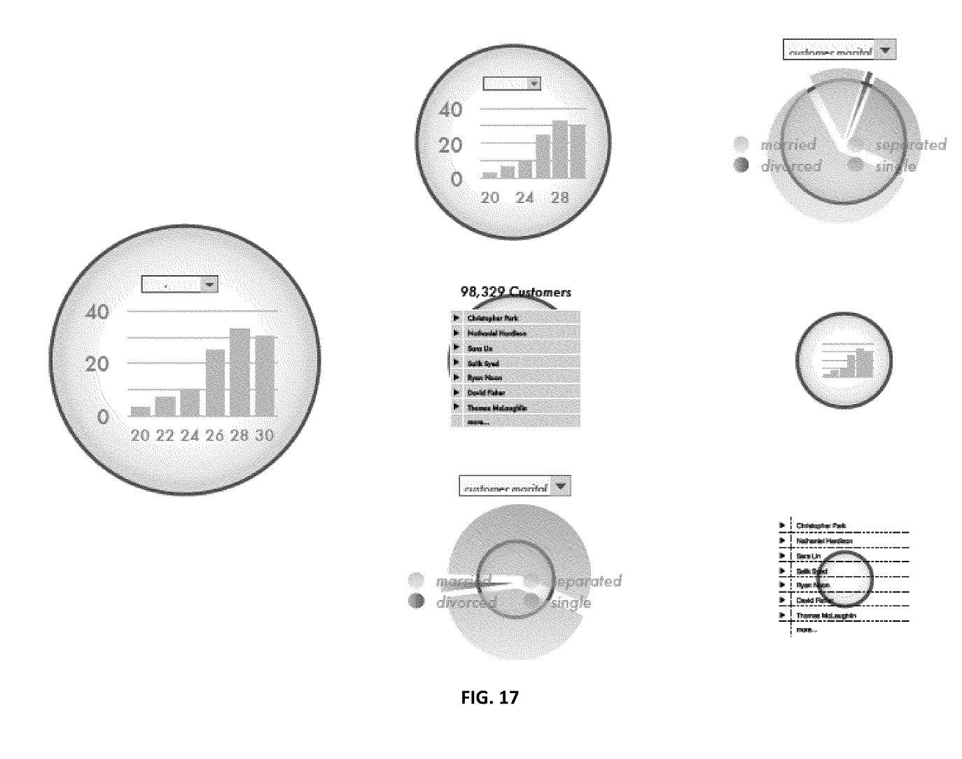

FIG. 17 depicts a variety of different dashboard visualizations that may be generated by the user interface module 116 and/or depicted on a display in some embodiments. In various embodiments, aggregations may be drawn over any number of queries (e.g., over any number of query result set(s) and/or subsets) to build interactive dashboard visualizations. Those skilled in the art will appreciate that the bar charts, pie graphs, and data structures depicted in FIG. 17 are exemplary. There may be any kind of dashboard visualization depicting information across any number of query result sets and/or subsets.

Dashboard visualizations may allow for the visualization of aggregate information associated with query result set(s) and/or subsets. For example, if the query result set comprises a list of email, the dashboard visualization may be a pie graph representing the number of email sent to different recipients. Those skilled in the art will appreciate that there may be any number of dashboard visualizations or graphic options depicting information regarding query result set(s) and/or subset(s).

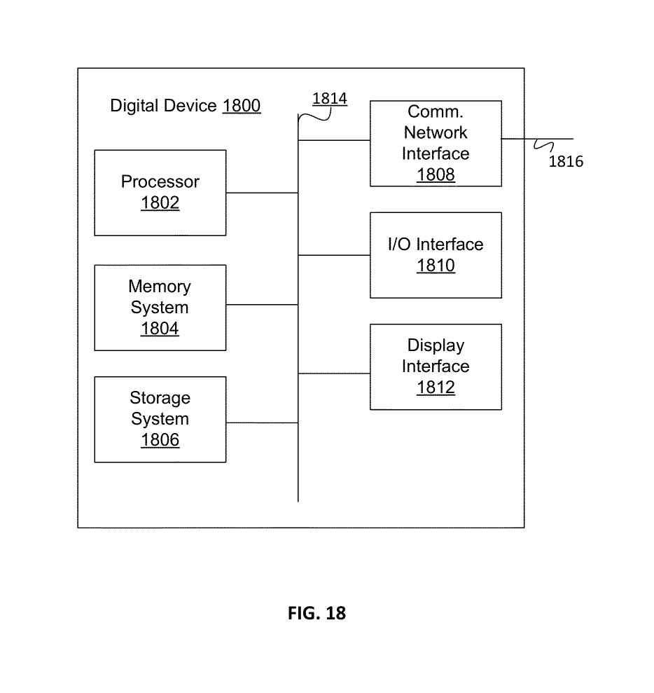

FIG. 18 is a block diagram of an exemplary digital device. The credential server 116 comprises a processor 1800, a memory system 1802, a storage system 1804, an I/O interface 1806, a communication network interface 1808, and a display interface 1810. The processor 1800 is configured to execute executable instructions (e.g., programs). In some embodiments, the processor 1800 comprises circuitry or any processor capable of processing the executable instructions.

The memory system 1802 is any memory configured to store data. Some examples of the memory system 1802 are storage devices, such as RAM or ROM. The memory system 1802 can comprise the ram cache. In various embodiments, data is stored within the memory system 1802. The data within the memory system 1802 may be cleared or ultimately transferred to the storage system 1804.

The storage system 1804 is any storage configured to retrieve and store data. Some examples of the storage system 1804 are flash drives, hard drives, optical drives, and/or magnetic tape. In some embodiments, the credential server 116 includes a memory system 1802 in the form of RAM and a storage system 1804 in the form of flash data. The storage system 1804 may comprise non-transitory computer readable media that may store instructions executable by a processor. Both the memory system 1802 and the storage system 1804 comprise computer readable media which may store instructions or programs that are executable by a computer processor including the processor 1800.

The optional input/output (I/O) interface 1806 is any device that receives input from the user and output data. The optional display interface 1810 is any device that is configured to output graphics and data to a display. In one example, the display interface 1810 is a graphics adapter. It will be appreciated that not all digital devices 102 comprise either the I/O interface 1806 or the display interface 1810.

The communication network interface (com. network interface) 1808 can be coupled to a network (e.g., the local area network 106 and communication network 118) via the link 1812. The communication network interface 1808 may support communication over an Ethernet connection, a serial connection, a parallel connection, or an ATA connection, for example. The communication network interface 1808 may also support wireless communication (e.g., 802.11 a/b/g/n, WiMax). It will be apparent to those skilled in the art that the communication network interface 1808 can support many wired and wireless standards.

The present invention(s) described above with reference to exemplary embodiments. It will be apparent to those skilled in the art that various modifications may be made and other embodiments can be used without departing from the broader scope of the present invention(s). Therefore, these and other variations upon the exemplary embodiments are intended to be covered by the present invention(s).

1. A system comprising:
a processor;
a database;
a display;
a query module configured to receive a first query and a second query, the first query to assist in retrieving a first query result set from the database, the second query to assist in retrieving a second query result set from the database;
a relationship module configured to identify a first subset associated with the first query result set and the second query result set based on at least some of the first query result set and at least some of the second query result set; and
a user interface configured to generate on the display a first node to represent the first query result set, a second node to represent the second query result set, and a first edge between the first node and the second node to represent the first subset.

2. The system of claim 1, wherein:
the query module is further configured to receive a third query, the third query to assist in retrieving a third query result set from the database,
the relationship module is further configured to identify a second subset associated with the first query result set and the third query result set based on at least some of the first query result set and at least some of the third query result set, and
the user interface is further configured to generate on the display a third node to represent the third query result set, and a second edge between the first node and the third node to represent the second subset.

3. The system of claim 1, wherein:
the query module is further configured to receive a third query, the third query to assist in retrieving a third query result set from the database,
the relationship module is further configured to identify a second subset associated with the first query result set and the third query result set, and to identify a third subset associated with the second query result set and the third query result set, the second subset being based on at least some of the first query result set and at least some of the third query result set, the third subset being based on at least some of the second query result set and at least some of the third query result set, and
the user interface is further configured to generate on the display a third node to represent the third query result set, a second edge between the first node and the third node to represent the second subset, and a third edge between the second node and the third node to represent the third subset.

4. The system of claim 1, wherein:
the query module is further configured to receive a third query, the third query to assist in retrieving a third query result set from the database,
the relationship module is further configured to identify a second subset associated with the first query result set, the second query result set, and the third query result set, the second subset being based on at least some of the first query result set, on at least some of the second query result set, and at least some of the third query result set, and
the user interface is further configured to generate on the display a third node to represent the third query result set, and an object to represent the second subset.

5. The system of claim 4, wherein the object comprises a number of sides, the number of sides being equal to a number of query result sets involved to identify the second subset.

6. The system of claim 1, wherein the first subset is based on shared information between members of the first query result set and the second query result set.

7. The system of claim 1, wherein the user interface is further configured to receive a user selection of the first node and to generate a display of at least some of the members of the first query result set.

8. The system of claim 1, wherein the user interface is further configured to receive a user selection of the first edge and to generate a display of at least some of the members of the first subset.

9. The system of claim 1, wherein the user interface is further configured to receive a user selection of the first node and the first edge and to generate a display of at least some of the shared members between the first query result set and the first subset.

10. The system of claim 9, wherein the user interface is further configured to generate a display of at least some of the shared information between the first query result set and the first subset, the display comprising a graph based on the at least some of the shared members between the first query result set and the first subset.

11. The system of claim 1, wherein:
the query module is further configured to receive a third query identifying at least one of the query result sets, the third query to assist in retrieving a third query result set from the database, the third query result set comprising at least some members of the identified at least one of the query result sets,
the relationship module is further configured to identify a second subset associated with the first query result set and the third query result set based on at least some of the first query result set and at least some of the third query result set, and
the user interface is further configured to generate on the display a third node to represent the third query result set and a second edge between the first node and the third node to represent the second subset.

12. The system of claim 1, wherein:
the query module is further configured to receive a third query identifying at least one of the query result sets, the third query to assist in retrieving a third query result set from the database, the third query result set comprising at least some members of the identified at least one of the query result sets, and
the user interface is further configured to generate on the display a third node to represent the third query result set and to remove at least one of the nodes associated with at least one of the identified at least one of the query result sets.

13. A method comprising:
receiving, by a processor of a digital device, a first query and a second query, the first query to assist in retrieving a first query result set from a database, the second query to assist in retrieving a second query result set from the database;
identifying, by the processor, a subset associated with the first query result set and the second query result set based on at least some of the first query result set and at least some of the second query result set; and
generating, on a display of a digital device, a first node to represent the first query result set, a second node to represent the second query result set, and an edge to represent the subset.

14. The method of claim 13, further comprising:
receiving a third query, the third query to assist in retrieving a third query result set from the database;
identifying a second subset associated with the first query result set and the third query result set based on at least some of the first query result set and at least some of the third query result set; and
generating on the display a third node to represent the third query result set, and a second edge between the first node and the third node to represent the second subset.

15. The method of claim 13, further comprising:
receiving a third query, the third query to assist in retrieving a third query result set from the database;
identifying a second subset associated with the first query result set and the third query result set, the second subset being based on at least some of the first query result set and at least some of the third query result set;
identifying a third subset associated with the second query result set and the third query result set, the third subset being based on at least some of the second query result set and at least some of the third query result set; and
generating on the display a third node to represent the third query result set, a second edge between the first node and the third node to represent the second subset, and a third edge between the second node and the third node to represent the third subset.

16. The method of claim 13, further comprising:
receiving a third query, the third query to assist in retrieving a third query result set from the database;
identifying a second subset associated with the first query result set, the second query result set, and the third query result set, the second subset being based on at least some of the first query result set, on at least some of the second query result set, and at least some of the third query result set; and
generating on the display a third node to represent the third query result set, and an object to represent the second subset.

17. The method of claim 16, wherein the object comprises a number of sides, the number of sides being equal to a number of query result sets involved to identify the second subset.

18. The method of claim 13, wherein the first subset is based on shared information between the first query result set and the second query result set.

19. The method of claim 13, further comprising receiving a user selection of the first node and generating a display of at least some of the members of the first query result set.

20. The method of claim 13, further comprising receiving a user selection of the first edge and generating a display of at least some of the members of the first subset.

21. The method of claim 13, further comprising receiving a user selection of the first node and the first edge and generating a display of at least some of the shared members between the first query result set and the first subset.

22. The method of claim 21, wherein generating the display of at least some of the shared members between the first query result set and the first subset comprises generating the display of a graph based on at least some information of the shared members between the first query result set and the first subset.

23. The method of claim 13, further comprising:
receiving a third query identifying at least one of the query result sets, the third query to assist in retrieving a third query result set from the database, the third query result set comprising at least some members of the identified at least one of the query result sets;
identifying a second subset associated with the first query result set and the third query result set based on at least some of the first query result set and at least some of the third query result set; and
generating on the display a third node to represent the third query result set, and a second edge between the first node and the third node to represent the second subset.

24. The method of claim 13, further comprising:
receiving a third query identifying at least one of the query result sets, the third query to assist in retrieving a third query result set from the database, the third query result set comprising at least some members of the identified at least one of the query result sets;
generating on the display a third node to represent the third query result set; and
removing from the display at least one of the nodes associated with at least one of the identified at least one of the query result sets.

25. A non-transitory computer readable medium comprising instructions executable by a processor for performing a method, the method comprising:
receiving, by a processor of a digital device, a first query and a second query, the first query to assist in retrieving a first query result set from a database, the second query to assist in retrieving a second query result set from the database;
identifying, by the processor, a subset associated with the first query result set and the second query result set based on at least some of the first query result set and at least some of the second query result set; and
generating, on a display of a digital device, a first node to represent the first query result set, a second node to represent the second query result set, and an edge to represent the subset.
